(19) United States
(12) Patent Application Publication
(10) Pub. No.: US 2016/0006010 A1
(43) Pub. Date: Jan. 7, 2016

(54) NEGATIVE ELECTRODE FOR SECONDARY BATTERY, METHOD FOR PRODUCING SAME, AND SECONDARY BATTERY USING SAME

(71) Applicant: NEC CORPORATION, Tokyo (JP)

(72) Inventors: Masahiro SUGURO, Tokyo (JP); Midori SHIMURA, Tokyo (JP); Noriyuki TAMURA, Tokyo (JP); Kentaro NAKAHARA, Tokyo (JP)

(73) Assignee: NEC Corporation, Tokyo (JP)

(21) Appl. No.: 14/765,173

(22) PCT Filed: Jan. 16, 2014
(86) PCT No.: PCT/JP2014/050706

§ 371 Date: Jul. 31, 2015

(30) Foreign Application Priority Data
Feb. 4, 2013 (JP) 2013-019951

(51) Int. Cl. H01M 2/16

(52) U.S. Cl. CPC H01M 2/1673; H01M 2/1653; H01M 2004/027

(57) ABSTRACT

The present invention relates to a negative electrode for a lithium secondary battery containing a lithium sulfonate represented by a general formula (I) and provides a secondary battery that is excellent in a cycle characteristic and a storage characteristic under a high temperature environment:

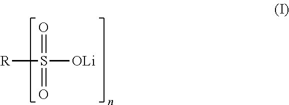

wherein R represents an n-valent aliphatic hydrocarbon group having 1 to 30 carbon atoms, an n-valent mononuclear aromatic group or an n-valent binuclear condensed aromatic group, and n represents 1 or 2.

### TECHNICAL FIELD

The present invention is an invention relating to a nonaqueous electrolyte solution secondary battery. More specifically, the present invention relates to a lithium secondary battery or a lithium ion secondary battery, particularly a nonaqueous electrolyte solution secondary battery with the problems of charge/discharge cycle lifetime, capacity retention characteristics and increase in resistance after storing at a high temperature overcome.

### BACKGROUND ART

Nonaqueous electrolyte solution lithium ion batteries or lithium secondary batteries using a carbon material, an oxide, a lithium alloy or a lithium metal as a negative electrode, and a lithium-containing transition metal complex oxide as a positive electrode, and further having an electrolyte solution containing a chain or cyclic carbonate solvent, have attracted attention as power supplies for cellular phones, laptop computers or the like because they can achieve a high energy density. Recently, they have attracted attention also as power supplies for motor drive in hybrid electric vehicles (HEV) or the like because of the improvement of output characteristics and long-term reliability such as a storage characteristic. In these secondary batteries, it is known that, for purpose of suppressing a reaction between the surface of electrodes and the solvent molecule, a plurality of additives are added to the electrolyte solution to form a film called protective coating (or coating) derived from the additives on the surface of the electrodes utilizing an electrochemical reaction in a charge/discharge process, thereby improving the basic characteristics and reliability of the secondary battery. The coating significantly affects charge/discharge efficiency, cycle lifetime and safety, and therefore it is known that the formation and control of the coating on the surface of electrodes is essential in order to achieve a battery with a high performance. In order to form the coating, various additives have been applied to an electrolyte solution.

Especially, it is known that a battery that is excellent in a cycle characteristic and a storage characteristic can be obtained by using an electrolyte solution with an inorganic lithium salt dissolved therein as shown in Patent Literature 1. However, although inorganic lithium salts are examined in the publication, an organic lithium salt of a monosulfonate compound, a disulfonate compound and the like used in the invention of the present application is neither described nor suggested.

Moreover, in Patent Literatures 2 to 6, uses of a sulfone compound having acid anhydride group, a sulfone compound having carbonate group, an oxocarbonic acid metal salt, a nitrile compound and a polymer having a sulfonic acid ion are described, respectively. However, also in these Patent Literatures, a lithium salt of a monosulfonate compound and a disulfonate compound used in the invention of the present application is neither described nor suggested.

In Patent Literature 7, sulfonate compounds having a biphenyl and bicyclo structure having two or more rings are primarily described and a large sulfonate compound in which four or more benzene rings and cyclohexane rings are linked together through single bonds is mainly examined. However, also in the Patent Literature, an aliphatic, mononuclear aromatic and binuclear fused aromatic lithium monosulfonate and lithium disulfonate used in the invention of the present application are neither described nor suggested.

Here, a slurry for producing an electrode has the problem of a poor dispersion stability and being easily gelled. The gelation of a slurry means that the fluidity and uniformity of a slurry are lost due to the increase of its viscosity, and makes it impossible to apply a slurry to a collector and worsens the application uniformity to an electrode, and thereby causes a problem such as difficulty in producing a positive electrode that satisfies a certain level of quality. The reason for the gelation of a slurry is thought that, in the case that a PVdF is used as a binder, when a slurry becomes alkaline, the PVdF as a binder is denatured. Considering this, in Patent Literature 8 is disclosed that, in order to suppress the gelation of a slurry for producing a positive electrode, a sulfonic acid and/or a lithium salt thereof is added into a positive electrode containing a lithium-nickel complex oxide as an active material, and thereby the gelation of a slurry can be suppressed, while the degradation of battery characteristics can also be suppressed. However, the Patent Literature relates to a positive electrode and fails to consider a negative electrode in contrast to the invention of the present application.

When a coating is formed on an electrode, more inexpensive and simpler method is required, and it has been an important subject to develop a process for producing an electrode that enables to exert more excellent battery characteristics than those of conventional batteries, even though being inexpensive and simple.

More specifically, a secondary battery using a sulfonic acid compound as an additive exhibits excellent battery characteristics, however, it had the following problem. In Patent Literatures 1 and 2, a sulfonic acid compound is used as an additive for an electrolyte solution, however, in order to use it as an additive for an electrolyte solution, the additive to be used needs to be soluble in a nonaqueous electrolyte solution. That is, previously, it was impossible to use a compound that is insoluble in a nonaqueous electrolyte solution as an additive.

Further, it has also been found that, when a compound that is insoluble in a nonaqueous electrolyte solution is mixed in an electrolyte solution and injected, the nozzle is clogged with the insoluble additive, resulting in injection failure. In addition, in Patent Literatures 3 to 5 is described a method for forming a sulfone compound layer on a silicon negative electrode layer formed through vapor deposition or CVD, and in order to form a sulfone compound layer on a silicon layer, this method requires further soaking the vapor-deposited silicon negative electrode in an aqueous solution in which a sulfone compound dissolves. Accordingly, another soaking process needs to be performed after a vapor deposition process, and therefore it is impossible to form a coating simply, which implied a problem of increase in man-hour and cost. Furthermore, in a soaking process, the soaking time, the concentration and the temperature must be controlled in detail, otherwise unevenness of the thickness or the shape of the sulfone compound layer will occur.

Moreover, in Patent Literature 8 is described a method for suppressing the gelation of a slurry for producing a positive electrode by adding a sulfonic acid and/or a lithium salt thereof into a positive electrode containing a lithium-nickel complex oxide as an active material. In the case that a PVdF is used as a binder, when a slurry becomes alkaline, the PVdF as a binder is deteriorated and gelled, and accordingly it is examined in this literature to suppress the gelation by adding a sulfonic acid to a slurry to neutralize. However, adding a sulfonic acid to a slurry makes the slurry acidic, and therefore there existed a problem of the embrittlement of an active material and a collector due to oxidation causing the pealing of an electrode and the degradation of battery characteristics. That is, while adding a sulfonic acid to a slurry has an effect of suppressing the gelation of an electrode, in contrast the application uniformity is degraded, causing an adverse effect on productivity and battery characteristics. Further, the approach of the Patent Literature is for suppressing the gelation by adding an acidic sulfonic acid and a neutral lithium salt thereof does not have the effect, while the difference of the effect between a sulfonic acid (acidic) and a lithium salt thereof (neutral) is not described therein.

### CITATION LIST

### Patent Literature

### Patent Literature 1: Japanese Patent Laid-Open No. 07-235297

### Patent Literature 2: Japanese Patent Laid-Open No. 2009-176719

### Patent Literature 3: Japanese Patent Laid-Open No. 2009-163890

### Patent Literature 4: Japanese Patent Laid-Open No. 2009-021229

### Patent Literature 5: Japanese Patent Laid-Open No. 2010-49928

### Patent Literature 6: Japanese Patent Laid-Open No. 2009-059514

### Patent Literature 7: Japanese Patent Laid-Open No. 2010-015885

### Patent Literature 8: Japanese Patent No. 4453242

### SUMMARY OF INVENTION

### Technical Problem

For the reasons as described above, it was previously difficult to use a lithium sulfonate, which is insoluble in a nonaqueous electrolyte solution. However, it is presumed that, among these lithium sulfonates, there are many suitable ones for obtaining a high-performance nonaqueous electrolyte solution secondary battery.

The present invention was made considering the above circumstances, and it is the object thereof to produce a secondary battery that is excellent in battery characteristics such as a cycle characteristic and a storage characteristic by using a lithium sulfonate, which is insoluble in a nonaqueous electrolyte solution.

### Solution to Problem

In order to solve the above problem, the present inventors intensively investigated various lithium sulfonates using insolubility in a nonaqueous electrolyte solution as a benchmark, and as a result have found that a lithium monosulfonate or a lithium disulfonate represented by Formula (I) is suitable for a negative electrode for a lithium secondary battery.

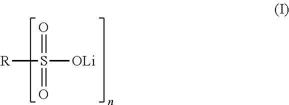

wherein

R represents n-valent aliphatic hydrocarbon group having 1 to 30 carbon atoms, n-valent mononuclear aromatic group or n-valent binuclear condensed aromatic group, and

n represents 1 or 2.

### Advantageous Effects of Invention

According to the present invention, a secondary battery that is excellent in battery characteristics such as a cycle characteristic and a storage characteristic can be provided.

More specifically, in the case that an additive that is insoluble in a nonaqueous electrolyte solution is used as an additive for an electrolyte solution, excellent battery characteristics can be achieved by applying the lithium sulfonate of the present invention to a negative electrode, even though the lithium sulfonate is insoluble in the electrolyte solution.

### BRIEF DESCRIPTION OF DRAWING

FIG. 1 is a schematic cross-sectional view illustrating the structure of an electrode element used in a laminated type secondary battery.

### DESCRIPTION OF EMBODIMENTS

Now, examples of the negative electrode of the present invention and a secondary battery capable of using the negative electrode will be described with respect to individual elements thereof.

### [Negative Electrode]

### <Negative Electrode Active Material Layer>

A negative electrode is prepared by, for example, binding a negative electrode active material to a negative electrode collector with a negative electrode binder. As the negative electrode active material in the present embodiment, any one capable of intercalating and deintercalating lithium may be used as long as it does not significantly deteriorate the effect of the present invention. A negative electrode is used having a structure in which a negative electrode active material layer is provided on a collector.

As the negative electrode active material, known negative electrode active materials may be arbitrary used as long as it is a material capable of intercalating and deintercalating lithium ions, without any other limitation. For example, it is preferable to use a carbonaceous material such as coke, acetylene black, mesophase microbeads and graphite; lithium metal; a lithium alloy such as a lithium-silicon and a lithium-tin; and lithium titanate or the like. Among them, it is the most preferable to use a carbonaceous material from the viewpoint of its good cycle characteristic and safety and further excellent continuous charge characteristics. It is noted that one negative electrode active material may be used singly or two or more negative electrode active materials may be used in any combination and ratio.

In addition, although the particle size of the negative electrode active material is arbitrary as long as it does not significantly deteriorate the effect of the present invention, it is usually 1 μm or more, preferably 15 μm or more, and usually 50 μm or less, preferably approximately 30 μm or less from the viewpoint of excellent battery characteristics such as initial efficiency, rate characteristics and a cycle characteristic. Further, as the carbonaceous material may be suitably used, for example, a material which is obtained by coating the above carbonaceous material with an organic substance such as pitch and thereafter burning it and a material which is obtained by forming more amorphous carbon than the above carbonaceous material on the surface by using a CVD method or the like. Here, examples of the organic substance used for coating include coal tar pitch from soft pitch to hard pitch; coal heavy oils such as dry distillation liquefaction oil; straight-run heavy oils such as atmospheric residue and vacuum residue; and petroleum heavy oils such as cracked heavy oil (e.g., ethylene heavy end), which is a byproduct generated in thermal cracking of crude oil, naphtha and the like. Also may be used a material obtained by pulverizing a solid residue obtained by distilling these heavy oils at 200 to 400° C. into 1 to 100 μm. In addition, a vinyl chloride resin, a phenol resin, an imide resin or the like may also be used. The negative electrode active material layer can be produced, for example, by roll-forming the above-mentioned negative electrode active material into a sheet electrode or compression-molding the negative electrode active material into a pellet electrode; however, usually as is the case with a positive electrode active material layer, the negative electrode active material layer can be produced by applying an application liquid obtained by slurrying the above-mentioned negative electrode active material, a binder, and as necessary various auxiliary agents or the like in a solvent to a collector and drying.

Examples of the negative electrode active material containing silicon include silicon and a silicon compound. Examples of the silicon include simple silicon. Examples of the silicon compound include a silicon oxide, a silicate, and a compound containing a transition metal and silicon, such as nickel silicide or cobalt silicide. A silicon compound has a function to relax expansion and contraction of the negative electrode active material itself caused in repeating the charge/discharge cycle, and is preferably used from the viewpoint of the charge/discharge cycle characteristic. Besides, some types of silicon compounds have a function to secure connection between silicon portions, and from this point of view, a silicon oxide is preferably used as the silicon compound. The silicon oxide is not especially limited, but for example, a silicon oxide is represented by SiOₓ (0<x<2). A silicon oxide may contain Li. A silicon oxide containing Li is represented by, for example, SiLi_{y}O_{z} (y>0 and 2>z>0). Besides, the silicon oxide may contain a slight amount of a metallic element or a nonmetallic element. The silicon oxide may contain one, two or more elements selected from the group consisting of, for example, nitrogen, boron and sulfur in a concentration of, for example, 0.1 to 5% by mass. If a slight amount of a metallic element or a nonmetallic element is contained, the electric conductivity of the silicon oxide can be improved. The silicon oxide may be crystalline or amorphous. The negative electrode active material preferably contains, in addition to the silicon or the silicon oxide, a carbon material capable of intercalating and deintercalating lithium ions. The carbon material may be contained in a state conjugated with the silicon or the silicon oxide. The carbon material has, similarly to the silicon oxide, functions to relax the expansion and contraction of the negative electrode active material itself caused in repeating the charge/discharge cycle, and to secure the connection between silicon portions of the negative electrode active material. Accordingly, if the silicon, the silicon oxide and the carbon material are used together, a better cycle characteristic can be attained.

As the carbon material, graphite, amorphous carbon, diamond-like carbon, a carbon nanotube, or a complex of these materials can be used. Here, graphite with high crystallinity has high electric conductivity and is excellent in adhesion to a positive electrode collector made of a metal such as copper and in voltage flatness. On the other hand, amorphous carbon with low crystallinity shows comparatively small volume expansion and hence attains a high effect to relax the volume expansion of the whole negative electrode, and degradation derived from ununiformity such as a grain boundary or a defect is difficult to occur therein. The content of the carbon material in the negative electrode active material is preferably 2% by mass or more and 50% by mass or less, and more preferably 2% by mass or more and 30% by mass or less.

As a method for preparing the negative electrode active material containing the silicon and the silicon compound, if, for example, a silicon oxide is used as the silicon compound, a method including mixing simple silicon with the silicon oxide and sintering the resulting mixture at a high temperature and reduced pressure may be employed. Alternatively, if a compound of a transition metal and silicon is used as the silicon compound, a method including mixing simple silicon with the transition metal and fusing the resulting mixture, or a method including coating the surface of simple silicon with the transition metal by vapor deposition or the like may be employed.

In addition to any of the aforementioned preparing methods, conjugation with carbon may be employed in combination. For example, by a method including introducing a sintered product of a mixture of simple silicon and a silicon compound into a gaseous atmosphere of an organic compound under non-oxygen atmosphere at high-temperature, or a method including mixing a sintered product of a mixture of simple silicon and a silicon oxide with a carbon precursor resin under non-oxygen atmosphere at high-temperature, a coating layer of carbon can be formed around a nucleus of the simple silicon and the silicon oxide. In this manner, effects to inhibit the volume expansion through the charge/discharge cycle and to further improve the cycle characteristic can be attained.

In the case that silicon is used as the negative electrode active material in the present embodiment, the negative electrode active material preferably consists of a complex containing silicon, a silicon oxide and a carbon material (hereinafter also referred to as Si/SiO/C complex). The whole or a part of the silicon oxide preferably has an amorphous structure. A silicon oxide having an amorphous structure can inhibit the volume expansion of the carbon material or the silicon used as the other components of the negative electrode active material. This mechanism has not been clarified yet, but it is presumed that a silicon oxide having an amorphous structure somehow affects the formation of a coating on an interface between the carbon material and the electrolyte solution. Besides, it seems that an amorphous structure includes a comparatively small number of elements derived from ununiformity such as a grain boundary or a defect. Incidentally, it can be confirmed by X-ray diffraction measurement (such as general XRD measurement) that the whole or a part of the silicon oxide has an amorphous structure. Specifically, if a silicon oxide does not have an amorphous structure, a peak peculiar to the silicon oxide is observed, but if the whole or a part of the silicon oxide has an amorphous structure, the peak peculiar to the silicon oxide is observed as a broad peak.

In the Si/SiO/C complex, the whole or a part of the silicon is preferably dispersed in the silicon oxide. By dispersing at least a part of the silicon in the silicon oxide, the volume expansion of the whole negative electrode can be more inhibited, and the decomposition of the electrolyte solution can be also inhibited. Incidentally, it can be confirmed by observation with a combination of a transmission electron microscope (general TEM observation) and energy dispersive X-ray spectroscopy (general EDX measurement) that the whole or a part of the silicon is dispersed in the silicon oxide. Specifically, a cross-section of a sample is observed, and the oxygen concentration in a silicon portion dispersed in the silicon oxide is measured, so as to confirm that the silicon portion is not an oxide.

In the Si/SiO/C complex, for example, the whole or a part of the silicon oxide has an amorphous structure, and the whole or a part of the silicon is dispersed in the silicon oxide. Such a Si/SiO/C complex can be prepared by, for example, a method disclosed in Japanese Patent Laid-Open No. 2004-47404. Specifically, the Si/SiO/C complex can be obtained, for example, by subjecting a silicon oxide to a CVD treatment under an atmosphere containing an organic gas such as a methane gas. The Si/SiO/C complex obtained by this method is in such a form that surfaces of particles of the silicon oxide containing silicon are coated with carbon. Besides, the silicon is present in the form of nanoclusters in the silicon oxide.

In the Si/SiO/C complex, the ratio among the silicon, the silicon oxide and the carbon material is not especially limited. The silicon is contained in the Si/SiO/C complex in a percentage of preferably 5% by mass or more and 90% by mass or less, and more preferably 20% by mass or more and 50% by mass or less. The silicon oxide is contained in the Si/SiO/C complex in a percentage of preferably 5% by mass or more and 90% by mass or less, and more preferably 40% by mass or more and 70% by mass or less. The carbon material is contained in the Si/SiO/C complex in a percentage of preferably 2% by mass or more and 50% by mass or less, and more preferably 2% by mass or more and 30% by mass or less.

Furthermore, the Si/SiO/C complex may be consist of a mixture of simple silicon, a silicon oxide and a carbon material, and can be prepared also by mixing simple silicon, a silicon oxide and a carbon material by using a mechanical milling. For example, the Si/SiO/C complex can be obtained by mixing simple silicon, a silicon oxide and a carbon material all in the form of particles. The average particle size of the simple silicon can be set, for example, to be smaller than the average particle size of the carbon material and the average particle size of the silicon oxide. In this manner, the simple silicon, which has a little volume change upon the charge/discharge cycle, has a relatively smaller particle size, and the carbon material and the silicon oxide, which have a large volume change, have relatively larger particle sizes. Therefore, generation of dendrite and particle size reduction of an alloy can be more effectively inhibited.

Besides, the average particle size of the simple silicon can be, for example, 20 μm or less and preferably 15 μm or less. Besides, the average particle size of the silicon oxide is preferably equal to or smaller than ½ of the average particle size of the carbon material, and the average particle size of the simple silicon is preferably equal to or smaller than ½ of the average particle size of the silicon oxide. Furthermore, it is more preferable that the average particle size of the silicon oxide is equal to or smaller than ½ of the average particle size of the carbon material and that the average particle size of the simple silicon is equal to or smaller than ½ of the average particle size of the silicon oxide. If the average particle sizes are controlled to fall in these ranges, the effect to relax the volume expansion can be more effectively attained, and a secondary battery excellent in balance between the energy density and the cycle life and efficiency can be obtained. More specifically, it is preferred that the average particle size of the silicon oxide is equal to or smaller than ½ of the average particle size of graphite and that the average particle size of the simple silicon is equal to or smaller than ½ of the average particle size of the silicon oxide. Furthermore specifically, the average particle size of the simple silicon can be, for example, 20 μm or less and is preferably 15 μm or less. Alternatively, a substance obtained by treating the surface of the Si/SiO/C complex with a silane coupling agent may be used as the negative electrode active material.

### <Negative Electrode Binder>

The negative electrode binder is not especially limited, and polyvinylidene fluoride, a vinylidene fluoride-hexafluoropropylene copolymer, a vinylidene fluoride-tetrafluoroethylene copolymer, a styrene-butadiene copolymer rubber, polytetrafluoroethylene, polypropylene, polyethylene, polyimide, polyamide-imide or the like can be used. Among these, polyimide, polyamide-imide, polyacrylic acids (including a lithium salt, a sodium salt and a potassium salt neutralized with an alkali), and carboxymethyl celluloses (including a lithium salt, a sodium salt and a potassium salt neutralized with an alkali) are preferably used because strong adhesion can be attained by them. The amount of the negative electrode binder to be used is preferably 2 to 10 parts by mass based on 100 parts by mass of the negative electrode active material from the viewpoint of a trade-off relationship between “sufficient binding force” and “high energy”.

### <Negative Electrode Collector>

As the material of the negative electrode collector, any of known materials may be arbitrarily used, and for example, a metal material such as copper, nickel or SUS is used. In particular, copper is particularly preferably used from the viewpoint of workability and cost. Besides, the collector is preferably precedently subjected to a surface-roughening treatment. Furthermore, the shape of the collector is arbitrary, and may be a foil shape, a plate shape, a mesh shape or the like. Alternatively, a perforated collector of an expanded metal or a punching metal can be used. In addition, in the case that a thin film is used as the collector, the preferable thickness and shape are also arbitrary.

### <Method of Preparing a Negative Electrode>

The negative electrode can be prepared, for example, by forming a negative electrode active material layer containing the negative electrode active material and the negative electrode binder on the negative electrode collector. The negative electrode active material layer can be formed by, for example, a doctor blade method, a die coater method, a CVD method, or a sputtering method. Alternatively, after precedently forming the negative electrode active material layer, a thin film of aluminum, nickel or an alloy of them may be formed thereon by vapor deposition, sputtering or the like to be used as the negative electrode collector.

According to the present invention, the lithium sulfonate represented by Formula (I) is added to a negative electrode slurry to be dispersed, and this slurry is applied and dried to thereby attach the lithium sulfonate on the surface of the negative electrode active material. According to the present invention, it becomes possible to improve battery characteristics by attaching a compound which could not be used as a coating-forming agent conventionally due to being insoluble in a nonaqueous electrolyte solution on the surface of the negative electrode active material. Because the lithium sulfonate is present on the surface of this negative electrode active material, the lowering of a cycle and the degradation of a storage characteristic of the battery, and swelling due to the generation of an inner gas can be suppressed to provide an excellent nonaqueous electrolyte solution secondary battery. Although this mechanism is not clear, the present inventors presume that the lithium sulfonate attached to the surface of the negative electrode forms a coating through a certain reaction at an initial charge.

More specifically, by attaching the lithium sulfonate of the present invention on the surface of the negative electrode active material, the negative electrode surface of the secondary battery is controlled and the decomposition of the solvent of the electrolyte solution is suppressed probably because a coating is formed at an initial charge. As a result, the cycle characteristic, the capacity retention characteristics and the like of a secondary battery can be improved and the increase in resistance can be suppressed.

### <Lithium Sulfonate>

According to one embodiment of the present invention, n preferably represents 1 in Formula (I), and in this case, the compound of Formula (I) represents a lithium monosulfonate.

In the lithium monosulfonate of Formula (I), R group is monovalent aliphatic hydrocarbon group having 1 to 30 carbon atoms, monovalent mononuclear aromatic group or monovalent binuclear condensed aromatic group.

In the case of a lithium monosulfonate, examples of the preferred aliphatic hydrocarbon group include, but are not limited to, substituted or unsubstituted linear alkyl group; substituted or unsubstituted branched alkyl group; substituted or unsubstituted cyclic alkyl group; substituted or unsubstituted cyclohexyl group; or, substituted or unsubstituted decahydronaphthyl group.

Examples of the preferred monovalent mononuclear aromatic group include, but are not limited to, substituted or unsubstituted phenyl group; substituted or unsubstituted tolyl group; substituted or unsubstituted xylyl group; substituted or unsubstituted benzyl group; substituted or unsubstituted trityl group; substituted or unsubstituted styryl group; substituted or unsubstituted pyridyl group; substituted or unsubstituted furyl group; substituted or unsubstituted thienyl group; or, substituted or unsubstituted morpholino group.

Examples of the preferred monovalent binuclear condensed aromatic group include, but are not limited to, substituted or unsubstituted tetralyl group; substituted or unsubstituted naphthoquinolyl group; substituted or unsubstituted naphthyl group; or, substituted or unsubstituted quinolyl group.

More preferably, examples of R group include substituted or unsubstituted linear alkyl group having 1 to 10 carbon atoms; or, substituted or unsubstituted branched alkyl group having 1 to 10 carbon atoms; substituted or unsubstituted phenyl group; substituted or unsubstituted tolyl group; substituted or unsubstituted xylyl group; substituted or unsubstituted naphthyl group; substituted or unsubstituted tetralyl group; or, substituted or unsubstituted morpholino group.

Most preferably, examples of R group include methyl, ethyl, propyl, phenyl, furyl and naphthyl group.

However, in R group, one or more CH₂ groups may be each independently replaced with —CH═CH—, —C≡C—, —O—, —CO—, —CO—O—, —O—CO— or —SiY¹Y²—.

Preferably, in R group, one or more CH₂ groups may be each independently replaced with —CH═CH—, —O—, —CO—, —CO—O—, —O—CO— or —SiY¹Y²—.

More preferably, the examples include —CH═CH—, —O—, —CO—, —CO—O— and —O—CO—.

In the above formula, Y¹ and Y² each independently represent H, alkyl group having 1 to 5 carbon atoms, alkoxy group having 1 to 5 carbon atoms, alkenyl group having 2 to 5 carbon atoms or alkynyl group having 2 to 5 carbon atoms.

Preferably, Y¹ and Y² each independently represent H or alkyl group having 1 to 5 carbon atoms.

More preferably, the examples include methyl, ethyl, propyl, butyl, pentyl, vinyl, prop-1- and -2-enyl, but-1-, -2- and -3-enyl, pent-1-, -2-, -3- and -4-enyl.

In the above group, one or more hydrogen atoms may be each independently replaced with halogen such as bromo, chloro, fluoro and iodo; alkyl group such as methyl, ethyl, propyl, butyl, pentyl, hexyl, heptyl, octyl, nonyl, decyl, undecyl, dodecyl, tridecyl, tetradecyl and pentadecyl; alkoxy group such as methoxy, ethoxy, propoxy, butoxy, pentoxy, hexyloxy, heptyloxy, octyloxy, nonyloxy, decyloxy, undecyloxy, dodecyloxy, tridecyloxy and tetradecyloxy; alkenyl group such as vinyl, prop-1- and -2-enyl, but-1-, -2- and -3-enyl, pent-1-, -2-, -3- and -4-enyl, hex-1-, -2-, -3-, -4- and -5-enyl, hept-1-, -2-, -3-, -4-, -5- and -6-enyl, oct-1-, -2-, -3-, -4-, -5-, -6- and -7-enyl, non-1-, -2-, -3-, -4-, -5-, -6-, -7- and -8-enyl, dec-1-, -2-, -3-, -4-, -5-, -6-, -7-, -8- and -9-enyl; alkynyl group such as ethynyl and propargyl group; substituted or unsubstituted cyclohexyl group; aryl group such as phenyl, tolyl, xylyl, benzyl, trityl, styryl, naphthyl, decahydronaphthyl, tetralyl and naphthoquinolyl; heterocyclic group such as furyl, thienyl, pyridyl, quinolyl and morpholino; nitrogen-containing group such as nitro, nitroso, cyano, isocyano, cyanato, isocyanato, amino and amide; oxygen-containing group such as hydroxy, carboxyl, acyl and alkoxycarbonyl; silicon-containing group such as silyl, monomethylsilyl, dimethylsilyl, trimethylsilyl, monophenylsilyl, diphenylsilyl and triphenylsilyl; or, sulfur-containing group such as thioalkyl and thioalkoxy.

Preferably, in the above group, one or more hydrogen atoms may be each independently replaced with halogen such as bromo, chloro, fluoro and iodo; alkyl group such as methyl, ethyl, propyl, butyl, pentyl, hexyl, heptyl and octyl; alkoxy group such as methoxy, ethoxy, propoxy, butoxy, pentoxy, hexyloxy, heptyloxy and octyloxy; alkenyl group such as vinyl, prop-1- and -2-enyl, but-1-, -2- and -3-enyl, pent 1, 2, 3 and 4-enyl, hex 1, 2, 3, 4 and -5-enyl; aryl group such as phenyl, tolyl, xylyl, benzyl, trityl, styryl, naphthyl, decahydronaphthyl, tetralyl and naphthoquinolyl; heterocyclic group such as furyl, thienyl, pyridyl, quinolyl and morpholino; nitrogen-containing group such as nitro, nitroso, cyano, isocyano, cyanato, isocyanato, amino and amide; oxygen-containing group such as hydroxy, carboxyl, acyl and alkoxycarbonyl; or, silicon-containing group such as silyl, monomethylsilyl, dimethylsilyl, trimethylsilyl, monophenylsilyl, diphenylsilyl and triphenylsilyl.

More preferably, the examples include bromo, chloro, fluoro, iodo, methyl, ethyl, propyl, methoxy, ethoxy, propoxy, vinyl, prop-1- and -2-enyl, phenyl, benzyl, styryl, naphthyl, furyl, nitro, nitroso, hydroxy, carboxyl, dimethylsilyl and diphenylsilyl.

Preferable examples of the lithium monosulfonate represented by Formula (I) include, but are not limited to, the following structures.

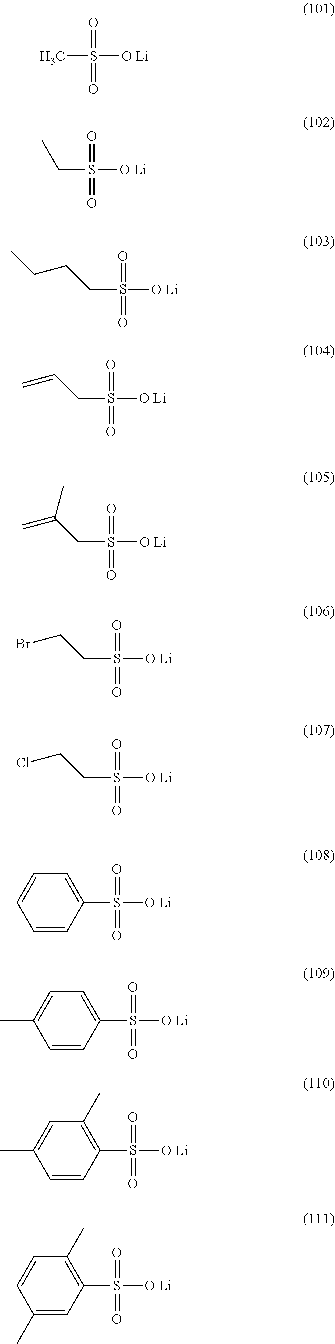

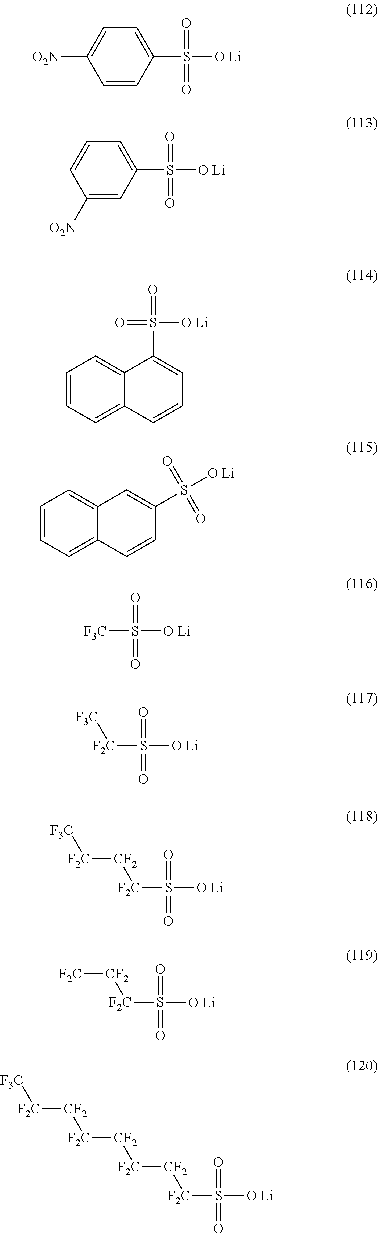

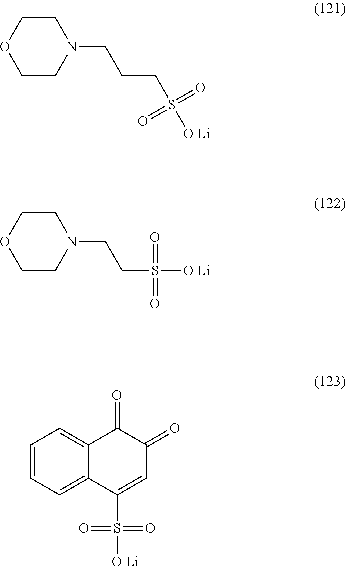

According to other embodiment of the present invention, n preferably represents 2, and in this case, the compound of Formula (I) represents a lithium disulfonate.

In the lithium disulfonate of Formula (I), R group is divalent aliphatic hydrocarbon group having 1 to 30 carbon atoms, divalent mononuclear aromatic group or divalent binuclear condensed aromatic group.

In the case of a lithium disulfonate, examples of the preferred aliphatic hydrocarbon group include, but are not limited to, substituted or unsubstituted linear alkylene group; substituted or unsubstituted branched alkylene group; substituted or unsubstituted cyclic alkylene group; substituted or unsubstituted cyclohexylene group; or, substituted or unsubstituted decahydronaphthylene group.

Examples of the preferred divalent mononuclear aromatic group include, but are not limited to, substituted or unsubstituted phenylene group; substituted or unsubstituted tolylene group; substituted or unsubstituted xylylene group; substituted or unsubstituted benzylidene group; substituted or unsubstituted pyridylene group; substituted or unsubstituted furylene group; substituted or unsubstituted thienylene group; or, substituted or unsubstituted morpholylene group.

Examples of the preferred divalent binuclear condensed aromatic group include, but are not limited to, substituted or unsubstituted tetralylene group; substituted or unsubstituted naphthoquinolylene group; substituted or unsubstituted naphthylene group; or, substituted or unsubstituted quinolylene group.

More preferably, examples of R group include substituted or unsubstituted linear alkylene group having 1 to 10 carbon atoms; or, substituted or unsubstituted branched alkylene group having 1 to 10 carbon atoms.

Most preferably, examples of R group include methyl, ethyl, propyl, butyl, propyl, isopropyl, isobutyl group.

However, in R group, one or more CH₂ groups may be each independently replaced with —CH═CH—, —C≡C—, —O—, —CO—, —CO—O—, —O—CO— or —SiY¹Y²—.

Preferably, in R group, one or more CH₂ groups may be each independently replaced with —SiY¹Y²—.

More preferably, the examples include —CH═CH—, —O—, —CO—, —CO—O— and —O—CO—.

In the above formula, Y¹ and Y² each independently represent H, alkyl group having 1 to 5 carbon atoms, alkoxy group having 1 to 5 carbon atoms, alkenyl group having 2 to 5 carbon atoms or alkynyl group having 2 to 5 carbon atoms.

Preferably, Y¹ and Y² each independently represent H or alkyl group having 1 to 5 carbon atoms.

More preferably, examples of Y¹ and Y² include methyl, ethyl, propyl, butyl, pentyl, vinyl, prop-1- and -2-enyl, but-1-, -2- and -3-enyl, pent-1-, -2-, -3- and -4-enyl.

Most preferably, both of Y¹ and Y² represent methyl. That is, R group has dimethylsilylene group.

In the above group, one or more hydrogen atoms may be each independently replaced with halogen selected form bromo, chloro, fluoro and iodo; alkyl group selected from methyl, ethyl, propyl, butyl, pentyl, hexyl, heptyl, octyl, nonyl, decyl, undecyl, dodecyl, tridecyl, tetradecyl and pentadecyl; alkoxy group selected from methoxy, ethoxy, propoxy, butoxy, pentoxy, hexyloxy, heptyloxy, octyloxy, nonyloxy, decyloxy, undecyloxy, dodecyloxy, tridecyloxy and tetradecyloxy; alkenyl group selected from vinyl, prop-1- and -2-enyl, but-1-, -2- and -3-enyl, pent-1-, -2-, -3- and -4-enyl, hex-1-, -2-, -3-, -4- and -5-enyl, hept-1-, -2-, -3-, -4-, -5- and -6-enyl, oct-1-, -2-, -3-, -4-, -5-, -6- and -7-enyl, non-1-, -2-, -3-, -4-, -5-, -6-, -7- and -8-enyl, dec-1-, -2-, -3-, -4-, -5-, -6-, -7-, -8- and -9-enyl; alkynyl group selected from ethynyl and propargyl group; substituted or unsubstituted cyclohexyl group; aryl group selected from phenyl, tolyl, xylyl, benzyl, trityl, styryl, naphthyl, decahydronaphthyl, tetralyl and naphthoquinolyl; heterocyclic group selected from furyl, thienyl, pyridyl, quinolyl and morpholino; nitrogen-containing group selected from nitro, nitroso, cyano, isocyano, cyanato, isocyanato, amino and amide; oxygen-containing group selected from hydroxy, carboxyl, acyl and alkoxycarbonyl; silicon-containing group selected from silyl, monomethylsilyl, dimethylsilyl, trimethylsilyl, monophenylsilyl, diphenylsilyl and triphenylsilyl; or, sulfur-containing group selected from thioalkyl and thioalkoxy.

Preferably, in the above group, one or more hydrogen atoms may be replaced with alkyl group selected from methyl, ethyl, propyl, butyl, pentyl, hexyl, heptyl and octyl.

More preferably, the examples include methyl, ethyl, propyl and butyl.

Preferable examples of the lithium disulfonate represented by Formula (I) include, but are not limited to, the following structures.

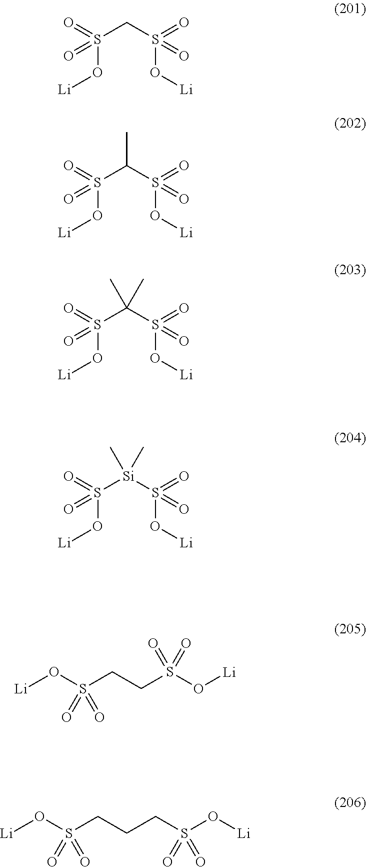

It is preferable to disperse the above-described lithium sulfonate in a slurry and apply and dry the slurry to attach the lithium sulfonate only on the surface of the negative electrode active material. This is because, if the amount of attachment is too large, then the coating to be formed of the lithium sulfonate probably becomes too thick, sometimes leading to the reduction of the lithium ion conductivity and the electron conductivity in the electrode. The degradation of these characteristics sometimes increases the resistance and deteriorates the high speed charge/discharge characteristics. Accordingly, the amount of the lithium sulfonate is preferably 0.001% by mass or more, more preferably 0.01% by mass or more, on the other hand, preferably 5% by mass or less, more preferably 3% by mass or less, and most preferably 1% by mass or less based on the amount of the active material.

Here, preferably, as a benchmark for insolubility in a nonaqueous electrolyte solution, the lithium sulfonate represented by Formula (I) described above is desirably insoluble in a solvent having a particular solubility parameter (sp value). Specifically, the lithium sulfonate represented by Formula (I) is desirably insoluble in a solvent having a sp value in a range of 8.8 to 11.5.

This is because of the following reason. That is, the solubility parameter (sp value) of organic solvents are known to be as follows: hexane (7.3), diethyl ether (7.4), diethyl carbonate (8.8), toluene (8.9), dimethyl carbonate (9.9), ethyl acetate (9.1), tetrahydrofuran (9.1), acetone (10.0), 1,4-dioxane (10.0), N-methylpyrrolidone (11.3), isopropyl alcohol (11.5), acetonitrile (11.9), dimethylformamide (12.0), dimethylsulfoxide (12.0), γ-butyrolactone (12.6), ethanol (12.7), propylene carbonate (13.3), ethylene carbonate (14.7), methanol (14.5), water (23.4). Generally, a solvent of an electrolyte solution is often a mixture of dimethyl carbonate, diethyl carbonate, propylene carbonate and ethylene carbonate. The sp value of a nonaqueous electrolyte solution calculated from these values is within a range of 8.8 to 11.5. Accordingly, “insoluble in a nonaqueous electrolyte solution” means in other words “insoluble in a solvent having a sp value of 8.8 to 11.5”.

### [Positive Electrode]

### <Positive Electrode Active Material Layer>

A positive electrode active material layer contains a positive electrode active material, and has a structure in which the positive electrode active material is bound on a positive electrode collector with a positive electrode binder. The positive electrode active material deintercalates lithium ions into an electrolyte solution at the time of charge and intercalates lithium from the electrolyte solution at the time of discharge, and examples thereof include lithium manganate having a layered structure, such as LiMnO₂ or LiₓMn₂O₄ (0<x<2), or lithium manganate having a spinel structure; LiCoO₂, LiNiO₂ or a substance in which a part of a transition metal of these is substituted with another metal; a lithium transition metal oxide in which a specific transition metal occupies less than a half of the whole structure, such as LiNi_{1/3}Co_{1/3}Mn_{1/3}O₂; and such a lithium transition metal oxide containing Li more excessively than in a stoichiometric composition. In particular, Li_{α}Ni_{β}Co_{γ}Al_{δ}O₂ (1≦α1.2, β+γ+δ=1, β≧0.7 and γ≦0.2), or Li_{α}Ni_{β}Co_{γ}Mn_{δ}O₂ (1≦α1.2, β+γ+δ=1, β≧0.6 and γ≦0.2) is preferable. One of these positive electrode active materials may be singly used, or two or more of them may be used in combination.

As the positive electrode binder which binds the above positive electrode active material to integrate together, specifically, any of those mentioned above as the negative electrode binder can be used. From the viewpoint of multiple use and low cost, polyvinylidene fluoride is preferable as the positive electrode binder. The amount of the positive electrode binder to be used is preferably 2 to 10 parts by mass based on 100 parts by mass of the positive electrode active material. In the case that the content of the positive electrode binder is 2 parts by mass or more, the adhesion properties between the active materials or between the active material and the collector are improved to bring the better cycle characteristic, and in the case of 10 parts by mass or less, the active material ratio is increased to improve the positive electrode capacity.

To the above positive electrode active material layer, a conductive assistant may be added for purpose of lowering the impedance of the positive electrode active material. As the conductive assistant may be used carbonaceous fine particles such as graphite, carbon black and acetylene black.

### <Positive Electrode Binder>

The positive electrode binder is not especially limited, and for example, polyvinylidene fluoride, a vinylidene fluoride-hexafluoropropylene copolymer, a vinylidene fluoride-tetrafluoroethylene copolymer, a styrene-butadiene copolymer rubber, polytetrafluoroethylene, polypropylene, polyethylene, polyimide, polyamide-imide or the like can be used. Among these, polyimide, polyamide-imide, polyacrylic acids (including a lithium salt, a sodium salt and a potassium salt neutralized with an alkali), and carboxymethyl celluloses (including a lithium salt, a sodium salt and a potassium salt neutralized with an alkali) are preferably used because strong adhesion can be attained by them. The amount of the positive electrode binder to be used is preferably 2 to 10 parts by mass based on 100 parts by mass of the negative electrode active material from the viewpoint of a trade-off relationship between “sufficient binding force” and “high energy”.

### <Positive Electrode Collector>

As the positive electrode collector may be any of those as long as it supports the positive electrode active material layer containing the positive electrode active material to be integrated together with a binder and has conductivity to enable connection to an external terminal, and specifically, any of those mentioned above as the negative electrode collector can be used.

### <Method for Producing Positive Electrode>

A method for producing a positive electrode is not especially limited, and is, for example, as follows: only a powder of a surface-treated Mn based positive electrode, or a powder of a surface-treated Mn based positive electrode and a powder of a lithium-nickel complex oxide is/are mixed with a conductive assistant and a binder in an appropriate dispersion medium which can dissolve the binder (a slurry method); the slurry is then applied to a collector such as an aluminum foil; the solvent is dried out; and the resultant is thereafter compressed to form a film by pressing or the like. It is noted that the conductive assistant is not especially limited and any one conventionally used such as carbon black, acetylene black, natural graphite, artificial graphite and carbon fiber may be used.

### [Electrolyte Solution]

The electrolyte solution can contain as an aprotic solvent one or more solvents selected from the group consisting of cyclic carbonates, chain carbonates, aliphatic carboxylates, γ-lactones, cyclic ethers and chain ethers and fluorine derivatives thereof. Specifically, for example, among propylene carbonate (PC), ethylene carbonate (EC), butylene carbonate (BC), cyclic carbonates such as vinylene carbonate (VC), chain carbonates such as dimethyl carbonate (DMC), diethyl carbonate (DEC), ethyl methyl carbonate (EMC), dipropyl carbonate (DPC), aliphatic carboxylates such as methyl formate, methyl acetate, ethyl propionate, γ-lactones such as γ-butyrolactone, chain ethers such as 1,2-diethoxyethane (DEE) and ethoxymethoxyethane (EME), cyclic ethers such as tetrahydrofuran and 2-methyltetrahydrofuran, dimethylsulfoxide, 1,3-dioxolane, formamide, acetamide, dimethylformamide, acetonitrile, propylnitrile, nitromethane, ethyl monoglyme, phosphoric acid triesters, trimethoxymethane, dioxolane derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, N-methylpyrrolidone, fluorinated carbonates, methyl-2,2,2-trifluoroethyl carbonate, methyl-2,2,3,3,3-pentafluoropropyl carbonate, trifluoromethylethylene carbonate, monofluoromethylethylene carbonate, difluoromethylethylene carbonate, 4,5-difluoro-1,3-dioxolan-2-one, and monofluoroethylene carbonate, one of them may be singly used, or two or more of them may be used in a mixture.

In the electrolyte solution for a secondary battery in the present embodiment, a lithium salt can be further contained as an electrolyte. In this manner, a lithium ion can be a transferring substance, and thereby battery characteristics can be improved. As a lithium salt, one or more substances selected from, for example, a lithium imide salt, LiPF₆, LiBF₄, LiAsF₆, LiSbF₆, LiClO₄, LiAlCl₄ and LiN(CₙF₂ₙ₊₁SO₂)(CₘF₂ₘ₊₁SO₂)(each of n and m is a natural number) can be contained. Further, it is particularly preferable to use LiPF₆ or LiBF₄. By using them, the electric conductivity of a lithium salt can be enhanced and the cycle characteristic of a secondary battery can be further improved.

### [Separator]

A separator is not especially limited, and a porous film or a nonwoven fabric of polypropylene, polyethylene or the like can be used. Alternatively, a separator obtained by laminating such a material may be used.

### [Outer Package]

An outer package is not especially limited, and for example, a laminated film can be used. Any laminated film can be appropriately selected to be used as long as it is stable against the electrolyte solution and has a sufficient steam barrier property. As the laminated film used as the outer package, for example, a laminated film of aluminum, silica, polypropylene coated with alumina, or polyethylene can be used. In particular, from the viewpoint of inhibiting the volume expansion, an aluminum laminated film is preferably used.

In a secondary battery using a laminated film as the outer package, the strain of an electrode element caused when a gas is generated is extremely large as compared with that caused in a secondary battery using a metal can as the outer package. This is because the laminated film is more easily deformed by the internal pressure of the secondary battery than the metal can. Furthermore, when sealing a secondary battery using a laminated film as the outer package, the pressure within the battery is generally decreased to be lower than the atmospheric pressure, and hence, there remains no spare room within the battery. Therefore, the generation of a gas immediately leads to the volume change of the battery or the deformation of an electrode element in some cases.

In a secondary battery of the present embodiment, these problems can be overcome. As a result, a laminated type lithium ion secondary battery that is inexpensive and shows an excellent degree of freedom in design of cell capacity by changing the number of laminated layers can be provided. A typical example of the layered structure of the laminated film is a structure in which a metal thin film layer and a heat-fusible resin layer are laminated. Another typical example of the layered structure of the laminated film is a structure in which a protective layer of a film of polyester such as polyethylene terephthalate or nylon is further laminated on a surface of the metal thin film layer opposite to the heat-fusible resin layer. When sealing a battery element, the battery element is surrounded with the heat-fusible resin layer opposed. As the metal thin film layer, for example, a foil of Al, Ti, Ti alloy, Fe, stainless steel, Mg alloy or the like having a thickness of 10 to 100 μm is used. A resin used in the heat-fusible resin layer is not especially limited as long as it is fusible with heat. For example, polypropylene, polyethylene, an acid-modified product of these resins, polyphenylene sulfide, polyester such as polyethylene terephthalate, polyamide, an ethylene-vinyl acetate copolymer, or an ionomer resin obtained by intermolecular bonding, with metal ions, of an ethylene-methacrylic acid copolymer or an ethylene-acrylic acid copolymer is used as the heat-fusible resin layer. The thickness of the heat-fusible resin layer is preferably 10 to 200 μm, and more preferably 30 to 100 μm.

### [Battery Structure]

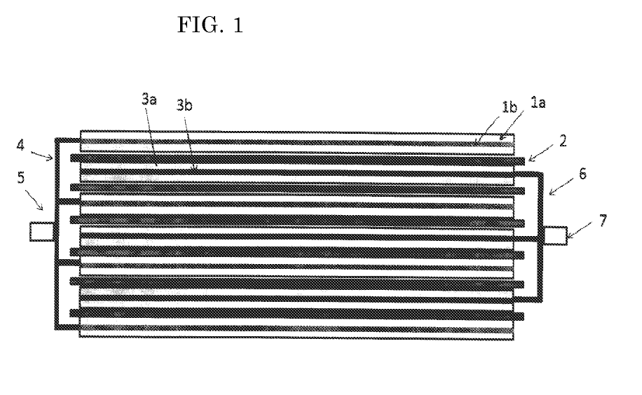

The structure of the secondary battery is not especially limited, and for example, a laminated type structure in which an electrode element including a positive electrode and a negative electrode opposing each other, and an electrolyte solution are housed in an outer package can be employed. FIG. 1 is a schematic cross-sectional view illustrating the structure of an electrode element of a laminated type secondary battery. In this electrode element, a plurality of positive electrodes 1 and a plurality of negative electrode 3 both having a planar structure are alternately stacked with a separator 2 sandwiched therebetween. Positive electrode collectors 1b of the respective positive electrodes 1 are welded to one another in end portions not covered with a positive electrode active material layer 1a so as to be electrically connected to one another, and a positive electrode terminal 4 is further welded to the welded portion among them. Negative electrode collectors 3b of the respective negative electrodes 3 are welded to one another in end portions not covered with a negative electrode active material layer 3a so as to be electrically connected to one another, and a negative electrode terminal 6 is further welded to the welded portion among them. Further, the positive electrode terminal 4 and the negative electrode terminal 6 are welded to a positive electrode tab 5 and a negative electrode tab 7, respectively. In the electrode element having such a planar layered structure, no portion has small R (like a portion close to a core of a winding structure), and therefore, such an electrode element has an advantage that it is difficult to be harmfully affected by the volume change of the electrode caused through the charge/discharge cycle as compared with an electrode element having a winding structure. In other words, it is effectively used as an electrode element using an active material with which the volume expansion is liable to occur. On the other hand, since an electrode is bent in an electrode element having a winding structure, the structure is easily warped if the volume change is caused. In particular, if a negative electrode active material largely changed in the volume through the charge/discharge cycle, such as a silicon oxide, is used, the capacity is largely lowered through the charge/discharge cycle in a secondary battery using an electrode element having a winding structure.

In the electrode element having a planar layered structure, however, if a gas is generated between the electrodes, there is a problem that the generated gas is liable to stay between the electrodes. This is for the following reason: In the electrode element having a winding structure, tension is applied to the electrodes and hence a distance between the electrodes is difficult to increase, but in the electrode element having a layered structure, a distance between the electrodes is easily increased. If an aluminum laminated film is used as the outer package, this problem becomes particularly conspicuous.

In the present invention, by attaching the lithium sulfonate represented by Formula (I) on the surface of the negative electrode active material, the aforementioned problem can be solved probably because a coating is formed, and hence, even a laminated type lithium ion secondary battery using a high-energy negative electrode can make long-life driving.

Accordingly, the secondary battery according to one embodiment of the present invention is a laminated type secondary battery containing an electrode element including a positive electrode and a negative electrode opposing each other, an electrolyte solution, and an outer package housing the electrode element and the electrolyte solution, wherein the negative electrode contains a negative electrode active material including at least one of a metal (a) alloyable with lithium and a metal oxide (b) capable of intercalating/deintercalating lithium ions, and is bound to a negative electrode collector with a negative electrode binder, and on the surface of the negative electrode active material a lithium sulfonate represented by Formula (I) is attached or a film thereof is formed. It is noted that the lithium sulfonate represented by Formula (I) is effectively used in a secondary battery using an electrode element having a winding structure.

### Other Embodiments of Invention

In the above embodiment, a compound commonly known as a positive electrode active material such as LiCoO₂ can be also used in a mixture with a positive electrode active material primarily containing a surface-treated Mn based positive electrode. In addition, an additive substance such as Li₂CO₃ conventionally used for safety or the like can be further added.

Further in the above embodiment, as an outer package of a battery can be adopted various shapes such as a rectangular type, a paper type, a laminated type, a cylindrical type and a coin type. The outer material and other constituent members are not especially limited and may be selected depending on a battery shape. As an example, a film-shaped outer package can be constituted with a film formed by laminating the aforementioned heat-fusible resin film on a heat-resistant resin film such as a polyethylene terephthalate directly or via an adhesive, or a single film of a heat-fusible resin film.

Furthermore, the electrolyte solution can further contain a compound having one or more sulfonyl groups in addition to a cyclic sulfonate having at least two sulfonyl groups.

### Examples

Now, the present invention will be specifically described with reference to examples, and it is noted that the present invention is not limited to these examples.

### [Preparation of Negative Electrode]

A negative electrode sheet was mixed in a ratio of carbon:PVDF=90:10 (% by mass) and dispersed in NMP. Further, a lithium sulfonate was added thereto at 0.5% by mass relative to the carbon, and further dispersed. The obtained lithium sulfonate-mixed slurry was applied to a copper foil with a thickness of 20 μm, dried, and then further pressed to prepare a negative electrode.

### [Preparation of Positive Electrode]

Lithium manganate, LiNi_{0.8}Co_{0.2}O₂ and a conductivity imparting agent was dry mixed and homogenously dispersed in N-methyl-2-pyrrolidone (NMP) with PVDF as a binder dissolved therein to prepare a slurry. Carbon black was used as the conductivity imparting agent. The slurry was applied to an aluminum metal foil with a thickness of 25 μm, and NMP was then evaporated, and the positive electrode sheet was pressed to prepare a positive electrode. The solid content ratio in the positive electrode was set to a mixing ratio (a=10) of lithium manganate: LiNi_{0.8}Co_{0.2}O₂:conductivity imparting agent:PVDF=72:8:10:10 (% by mass).

### [Preparation of Laminate Cell]

Two laminated films having a structure in which a polypropylene resin (sealing layer, thickness: 70 μm), a polyethylene terephthalate (20 μm), aluminum (50 μm) and a polyethylene terephthalate (20 μm) were laminated in this order were cut out in a predetermined size, and in one portion thereof were formed concavities having a bottom surface portion and a side surface portion fitted to the size of the above laminate electrode body, respectively. These were disposed so as to oppose to each other with the laminate electrode body sandwiched therebetween and the periphery thereof was heat-fused to prepare a film outer package battery. Before sealing the last one side by heat-fusing, an electrolyte solution of LiPF₆ used as a supporting electrolyte dissolved in a concentration of 1 mol/L in a carbonate nonaqueous electrolyte solvent consisting of EC/DEC=30/70 (in a volume ratio) was injected, and thereafter the laminate electrode body was impregnated therewith while reducing the pressure to 0.1 atm, and sealed, thereby producing an aluminum-laminated type secondary battery.

### [Evaluation of Battery Characteristics]

The aluminum-laminated battery was charged to a final voltage of 4.3 V and subsequently discharged to 2.5 V at a room temperature (25° C.). Thereafter, evaluations of cycle charge/discharge and a storage characteristic were performed at 60° C. at a constant current and voltage, and thereby capacity retention was evaluated.

### Example 1

A negative electrode was prepared by adding 0.5% by mass of the compound represented by Formula (101) as the lithium sulfonate represented by Formula (I) relative to the carbon. The negative electrode was cut out in a predetermined size and an aluminum-laminated cell was produced by using the above-mentioned method.

### Examples 2 to 4

Aluminum-laminated type secondary batteries were produced in the same manner as in Example 1 except that the compounds represented by Formulae (109), (116) and (117) were respectively used as the lithium sulfonate.

### Examples 5 to 8

Aluminum-laminated type secondary batteries were produced in the same manner as in Example 1 except that 1.0% by mass of the compounds represented by Formulae (101), (109), (116) and (117) were respectively used as the lithium sulfonate.

### Examples 9 to 12

Aluminum-laminated type secondary batteries were produced in the same manner as in Example 1 except that 0.5% by mass of the compounds represented by Formulae (201), (202), (203) and (204) were respectively used as the lithium sulfonate.

### Comparative Example 1

An Aluminum-laminated cell was produced in the same manner as in Example 1 except that a negative electrode was prepared without adding a lithium sulfonate to the negative electrode slurry in preparing the negative electrode.

### <Evaluation>

In the secondary batteries produced in Examples 1 to 8 and Comparative Example 1, cycle characteristics and storage characteristics shown under a high-temperature environment were evaluated. Specifically, each secondary battery was subjected to a test in which a charge/discharge cycle was repeated 200 times in a voltage range of 2.5 V to 4.1 V in a thermostat chamber kept at 60° C. Then, a retention ratio was calculated as (the discharge capacity at 200th cycle)/(the discharge capacity at 5th cycle) (unit: %). Besides, regarding to a storage characteristic, an expansion ratio was calculated as (the capacity before storage at a high temperature)/(the capacity after two week storage) (unit: %). The results are shown in Table 1. Incidentally, the retention ratio was determined as “Excellent” when it is 95% or more, determined as “Good” when it is 90% or more and less than 95%, determined as “Poor” when it is less than 90%.

TABLE 1
Evaluation Results

| | | | Cycle | | Storage | |
|---|---|---|---|---|---|---|
| | Lithium | | characteristic | | characteristic | |
| | sulfonate | | Reten- | | Reten- | |
| | Com- | % by | tion | Determi- | tion | Determi- |
| Examples | pound | mass | ratio/% | nation | ratio/% | nation |
| Example 1 | (2) | 0.5 | 94 | Excellent | 94 | Excellent |
| Example 2 | (10) | 0.5 | 95 | Excellent | 95 | Excellent |
| Example 3 | (17) | 0.5 | 96 | Excellent | 95 | Excellent |
| Example 4 | (18) | 0.5 | 97 | Excellent | 97 | Excellent |
| Example 5 | (2) | 1.0 | 93 | Excellent | 94 | Excellent |
| Example 6 | (10) | 1.0 | 95 | Excellent | 95 | Excellent |
| Example 7 | (17) | 1.0 | 96 | Excellent | 97 | Excellent |
| Example 8 | (18) | 1.0 | 96 | Excellent | 97 | Excellent |
| Example 9 | (201) | 0.5 | 95 | Excellent | 94 | Excellent |
| Example 10 | (202) | 0.5 | 96 | Excellent | 95 | Excellent |
| Example 11 | (203) | 0.5 | 94 | Excellent | 93 | Excellent |
| Example 12 | (204) | 0.5 | 97 | Excellent | 98 | Excellent |
| Compara. | — | — | 88 | Poor | 87 | Poor |
| Example 1 | | | | | | |

From the above result, it has been proved that a high recycle characteristic and storage characteristic can be achieved by using the lithium sulfonate represented by Formula (I).

### INDUSTRIAL APPLICABILITY

The present embodiment can be utilized in, for example, all the industrial fields requiring a power supply and the industrial fields pertaining to the transportation, storage and supply of electric energy. Specifically, it can be used in, for example, power supplies for mobile equipment such as cellular phones and laptop computers; power supplies for moving/transporting media such as trains, satellites and submarines including electrically driven vehicles such as an electric vehicle, a hybrid vehicle, an electric motorbike, and an electric-assisted bike; backup power supplies for UPSs; and electricity storage facilities for storing electric power generated by photovoltaic power generation, wind power generation and the like.

### [Supplement]

The present application also relates to the following items.

(Supplement 1) A lithium secondary battery comprising an outer package housing at least the negative electrode according to the present application and a nonaqueous solvent electrolyte solution, wherein the outer package is a laminated film.

(Supplement 2) The laminated type lithium secondary battery according to Supplement 1, wherein a positive electrode and the negative electrode are laminated with a separator sandwiched therebetween in an electrode element.

(Supplement 3) An assembled battery using two or more lithium secondary batteries, the lithium secondary battery comprising an electrode element including a positive electrode and a negative electrode opposing each other, and a nonaqueous solvent electrolyte solution, wherein a lithium sulfonate represented by Formula (I) is provided on a surface of an active material of the negative electrode.

(Supplement 4) A lithium secondary battery comprising an electrode element including a positive electrode and a negative electrode opposing each other, and a nonaqueous solvent electrolyte solution, wherein a lithium sulfonate represented by Formula (I) is provided on a surface of an active material of the negative electrode, or a vehicle comprising, as a motor driving power supply, an assembled battery using two or more the lithium secondary battery.

### EXPLANATION OF SYMBOLS

1a positive electrode active material layer
1b positive electrode collector
2 separator
3a negative electrode active material layer
3b negative electrode collector
4 positive electrode terminal
5 positive electrode tab
6 negative electrode terminal
7 negative electrode tab

1. A negative electrode for a lithium secondary battery containing a lithium sulfonate represented by a general formula (I): 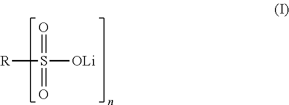
wherein
R represents an n-valent aliphatic hydrocarbon group having 1 to 30 carbon atoms, an n-valent mononuclear aromatic group or an n-valent binuclear condensed aromatic group, and
n represents 1 or 2.

2. The negative electrode for the lithium secondary battery according to claim 1, wherein
n represents 1,
R represents a substituted or unsubstituted linear alkyl group; a substituted or unsubstituted branched alkyl group; a substituted or unsubstituted cyclic alkyl group;
a substituted or unsubstituted cyclohexyl group; a substituted or unsubstituted decahydronaphthyl group; a substituted or unsubstituted tetralyl group; a substituted or unsubstituted naphthoquinolyl group; a substituted or unsubstituted phenyl group; a substituted or unsubstituted tolyl group; a substituted or unsubstituted xylyl group; a substituted or unsubstituted benzyl group; a substituted or unsubstituted trityl group; a substituted or unsubstituted styryl group; a substituted or unsubstituted naphthyl group; a substituted or unsubstituted furyl group; a substituted or unsubstituted thienyl group; a substituted or unsubstituted pyridyl group; a substituted or unsubstituted quinolyl group; or a substituted or unsubstituted morpholino group,
in the above groups, one or more CH₂ groups may be each independently replaced with —CH═CH—, —C≡C—, —O—, —CO—, —CO—O—, —O—CO— or —SiY¹Y²—,
in which Y¹— and Y² each independently represent H, an alkyl group having 1 to 5 carbon atoms, an alkoxy group having 1 to 5 carbon atoms, an alkenyl group having 2 to 5 carbon atoms or an alkynyl group having 2 to 5 carbon atoms, and
in the above groups, one or more hydrogen atoms may be each independently replaced with a halogen selected form bromo, chloro, fluoro and iodo; an alkyl group selected from methyl, ethyl, propyl, butyl, pentyl, hexyl, heptyl, octyl, nonyl, decyl, undecyl, dodecyl, tridecyl, tetradecyl and pentadecyl; an alkoxy group selected from methoxy, ethoxy, propoxy, butoxy, pentoxy, hexyloxy, heptyloxy, octyloxy, nonyloxy, decyloxy, undecyloxy, dodecyloxy, tridecyloxy and tetradecyloxy; an alkenyl group selected from vinyl, prop-1- and -2-enyl, but-1-, -2- and -3-enyl, pent-1-, -2-, -3- and -4-enyl, hex-1-, -2-, -3-, -4- and -5-enyl, hept-1-, -2-, -3-, -4-, -5- and -6-enyl, oct-1-, -2-, -3-, -4-, -5-, -6- and -7-enyl, non-1-, -2-, -3-, -4-, -5-, -6-, -7- and -8-enyl, dec-1-, -2-, -3-, -4-, -5-, -6-, -7-, -8- and -9-enyl; an alkynyl group selected from ethynyl and propargyl group; a substituted or unsubstituted cyclohexyl group; an aryl group selected from phenyl, tolyl, xylyl, benzyl, trityl, styryl, naphthyl, decahydronaphthyl, tetralyl and naphthoquinolyl; a heterocyclic group selected from furyl, thienyl, pyridyl, quinolyl and morpholino; a nitrogen-containing group selected from nitro, nitroso, cyano, isocyano, cyanato, isocyanato, amino and amide; an oxygen-containing group selected from hydroxy, carboxyl, acyl and alkoxycarbonyl; a silicon-containing group selected from silyl, monomethylsilyl, dimethylsilyl, trimethylsilyl, monophenylsilyl, diphenylsilyl and triphenylsilyl; or a sulfur-containing group selected from thioalkyl and thioalkoxy.

3. The negative electrode for the lithium secondary battery according to claim 2, wherein the lithium sulfonate represented by the general formula (I) is a compound selected from the group consisting of following formulae:

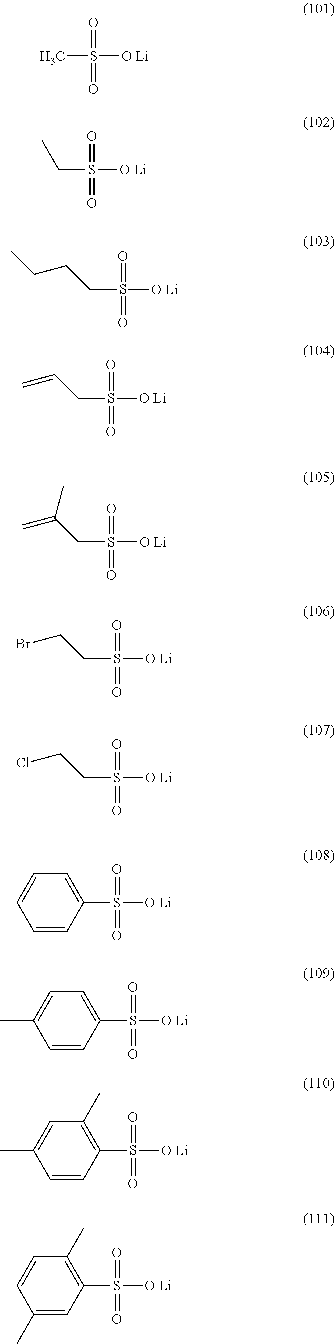

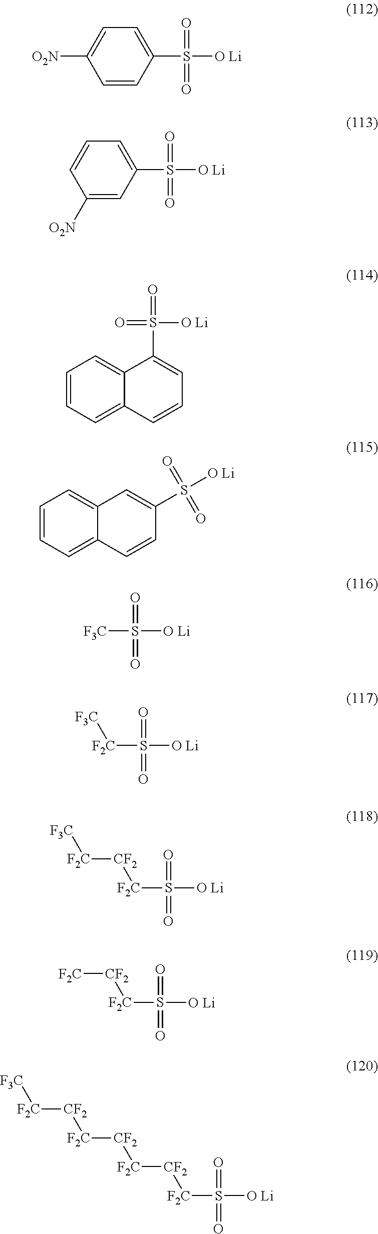

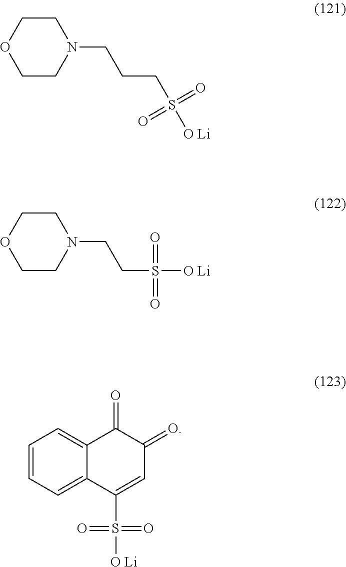

4. The negative electrode for the lithium secondary battery according to claim 1, wherein
n represents 2,
R represents a substituted or unsubstituted linear alkylene group; a substituted or unsubstituted branched alkylene group; a substituted or unsubstituted cyclic alkylene group; a substituted or unsubstituted cyclohexylene group; a substituted or unsubstituted decahydronaphthylene group; a substituted or unsubstituted tetralylene group; a substituted or unsubstituted naphthoquinolylene group; a substituted or unsubstituted phenylene group; a substituted or unsubstituted tolylene group; a substituted or unsubstituted xylylene group; a substituted or unsubstituted benzylidene group; a substituted or unsubstituted naphthylene group; a substituted or unsubstituted furylene group; a substituted or unsubstituted thienylene group; a substituted or unsubstituted pyridylene group; a substituted or unsubstituted quinolylene group; or a substituted or unsubstituted morpholylene group,
in the above groups, one or more CH₂ groups may be each independently replaced with —CH═CH—, —C≡C—, —O —, —CO—, —CO—O—, —O—CO— or —SiY¹Y²—,
in which Y¹— and Y² each independently represent H, an alkyl group having 1 to 5 carbon atoms, an alkoxy group having 1 to 5 carbon atoms, an alkenyl group having 2 to 5 carbon atoms or an alkynyl group having 2 to 5 carbon atoms, and
in the above groups, one or more hydrogen atoms may be each independently replaced with a halogen selected form bromo, chloro, fluoro and iodo; an alkyl group selected from methyl, ethyl, propyl, butyl, pentyl, hexyl, heptyl, octyl, nonyl, decyl, undecyl, dodecyl, tridecyl, tetradecyl and pentadecyl; an alkoxy group selected from methoxy, ethoxy, propoxy, butoxy, pentoxy, hexyloxy, heptyloxy, octyloxy, nonyloxy, decyloxy, undecyloxy, dodecyloxy, tridecyloxy and tetradecyloxy; an alkenyl group selected from vinyl, prop-1- and -2-enyl, but-1-, -2- and -3-enyl, pent-1-, -2-, -3- and -4-enyl, hex-1-, -2-, -3-, -4- and -5-enyl, hept-1-, -2-, -3-, -4-, -5- and -6-enyl, oct-1-, -2-, -3-, -4-, -5-, -6- and -7-enyl, non-1-, -2-, -3-, -4-, -5-, -6-, -7- and -8-enyl, dec-1-, -2-, -3-, -4-, -5-, -6-, -7-, -8- and -9-enyl; an alkynyl group selected from ethynyl and propargyl group; a substituted or unsubstituted cyclohexyl group; an aryl group selected from phenyl, tolyl, xylyl, benzyl, trityl, styryl, naphthyl, decahydronaphthyl, tetralyl and naphthoquinolyl; a heterocyclic group selected from furyl, thienyl, pyridyl, quinolyl and morpholino; a nitrogen-containing group selected from nitro, nitroso, cyano, isocyano, cyanato, isocyanato, amino and amide; an oxygen-containing group selected from hydroxy, carboxyl, acyl and alkoxycarbonyl; a silicon-containing group selected from silyl, monomethylsilyl, dimethylsilyl, trimethylsilyl, monophenylsilyl, diphenylsilyl and triphenylsilyl; or a sulfur-containing group selected from thioalkyl and thioalkoxy.

5. The negative electrode for the lithium secondary battery according to claim 4, wherein the lithium sulfonate represented by the general formula (I) is a compound selected from the group consisting of following formulae:

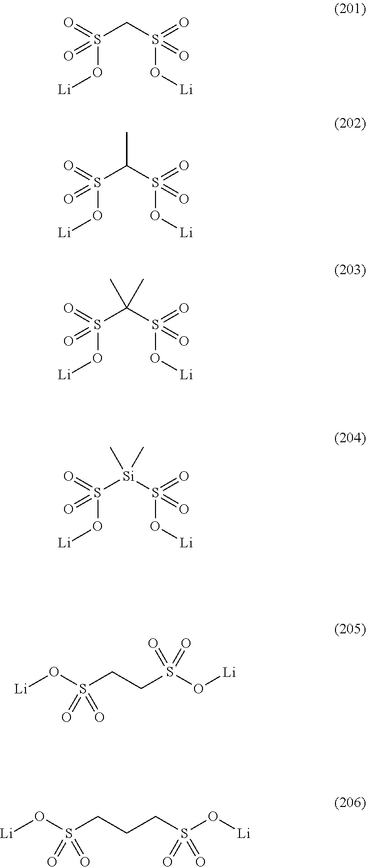

6. The negative electrode for the lithium secondary battery according to claim 1, wherein the lithium sulfonate represented by the general formula (I) is insoluble in a solvent having a solubility parameter (sp value) of 8.8 to 11.5.

7. The negative electrode for the lithium secondary battery according to claim 1, wherein the lithium sulfonate defined in claim 1 is attached on or forming a coating on a surface of a negative electrode active material.

8. The negative electrode for the lithium secondary battery according to claim 7, wherein an amount of the lithium sulfonate relative to that of the negative electrode active material is 0.001% by mass or more and 5.0% by mass or less.

9. A lithium secondary battery comprising: an electrode element including a positive electrode and a negative electrode opposing to each other, and a nonaqueous solvent electrolyte solution,
wherein a lithium sulfonate represented by a general formula (I) is provided on a surface of an active material of the negative electrode: 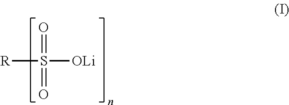
wherein
R represents an n-valent aliphatic hydrocarbon group having 1 to 30 carbon atoms, an n-valent mononuclear aromatic group or an n-valent binuclear condensed aromatic group, and
n represents 1 or 2.

10. A method for producing a negative electrode for a lithium secondary battery containing a lithium sulfonate represented by a general formula (I): 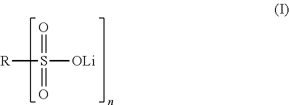
wherein
R represents an n-valent aliphatic hydrocarbon group having 1 to 30 carbon atoms, an n-valent mononuclear aromatic group or an n-valent binuclear condensed aromatic group, and
n represents 1 or 2,
comprising the steps of:
preparing a slurry by dispersing the lithium sulfonate, and
applying and drying the slurry.
